(19) United States
(12) Patent Application Publication
(10) Pub. No.: US 2010/0098943 A1
(43) Pub. Date: Apr. 22, 2010

(54) Flame retardant clear films

(76) Inventors: Marina Temchenko, Swampscott, MA (US); Samuel Lim, Lynn, MA (US)

Correspondence Address: CHRISTIE, PARKER & HALE, LLP, PO BOX 7068, PASADENA, CA, 91109-7068, US

(21) Appl. No.: 11/595,535

(22) Filed: Nov. 9, 2006

Related U.S. Application Data
(60) Provisional application No. 60/736,090, filed on Nov. 9, 2005.

(51) Int. Cl. C09J 7/02; C09J 131/02; C09D 5/18; C08K 5/49

(52) U.S. Cl. 428/355 AC; 428/343; 428/355 R; 106/18.14; 524/115

(57) ABSTRACT

Compositions for creating flame-retardant, optically clear films without using halogen based flame retardants, including a coating containing phosphorous-based fire retardant materials, an acrylic or polyester adhesive base, and an organic solvent. Composite film structures containing the flame retardant coating may include a plurality of polymeric films and or coatings separated by flame retardant materials.

### CROSS-REFERENCE TO RELATED APPLICATION

This application claims priority of provisional patent application No. 60/736,090, filed on Nov. 9, 2005.

### BACKGROUND INFORMATION

Criminal damage or vandalism is defined by law as “intentionally or recklessly destroying or damaging any property belonging to another without lawful excuse” [Criminal Damage Act 1971]. Vandalism and graffiti are common on most of the developed world's urban railway and transit systems, and cause economic and esthetic damage. To combat graffiti, thin, transparent, practically undetectable polymeric anti-graffiti films have been introduced to the market. However, hooligans, in attempt to destroy anti-graffiti films, have set them on fire, generating not only significant financial losses, but more importantly, human fatalities and injuries. Fires in confined spaces, such as airplanes, trains, ships, buses and other motorized vehicles are especially damaging, because the passengers have a limited means for egress.

Another related use of films is in airplane cockpit sunshades. Cockpit sunshades are essential part of the modern aircrafts in protecting crewmembers from excessive heat. Cockpit temperatures in aircrafts exposed to high air temperatures and radiation loads may exceed outside temperatures by approximately 20° C. Incoming sunlight increases the heat stress on crewmembers, both by raising air temperature and by directly heating exposed skin and clothing, thus causing crew performance decrements as well as diminishing acceleration tolerance.

There are many types of sunshades to control or prevent the sun from shining through a window, or to provide for entry of light with some degree of thermal insulation. Most of these sunshades are made of materials which could propagate the flame. Aircraft vulnerability to in-flight fires has always been one of the important safety concerns of the aviation industry. The flammability of aircraft interior materials is addressed by standards contained in Title 14 Code of Federal Regulations Part 25. Therefore there is a strong need in an effective, low-cost, non-toxic, optically clear, esthetically acceptable flame resistant aircraft sunshade material.

Another related use of flame retardant materials is in Safety and Security Films. An explosion is a sudden increase in volume and release of energy in a violent manner, usually with the generation of high temperatures and the release of gases. Should the explosion occur in urban area, shattered window glass and other objects become dangerous missiles in the air jets. Safety and Security Window Films help hold broken glass together during bomb blasts, destructive weather conditions, explosions, or housebreaks, thus preventing injuries and fatalities. Another danger associated with blasts is a fire. Primary fires are ignited by the thermal pulse, and secondary fires result from blast damage, such as broken utility lines, overturned appliances, electrical short circuits, etc. Flammable building materials, furniture and debris created by the blast provide the fuel to support fires, causing them to spread, involving other combustible objects and buildings. Spreading of a fire can be limited by reducing the combustible content or by use of fire retardant treated materials.

In order to lower the ignition susceptibility of polymeric films and/or flame spread, flame retardants can be used. Flame retardant agents generally function to reduce:

i) heat release rate of a material;

ii) rate of combustion, degradation and consumption of a material (fire extinction); and/or

iii) smoke emission, and evolution of toxic gases.

As a result, flame retardant agents can significantly increase the available escape time before flashover or the development of an incapacitating atmosphere occurs and, thereby, reduces the exposure of human beings and animals to toxic gases and burning.

Families of flame retardants include: (a) chlorinated flame retardants; (b) brominated flame retardants; (c) phosphorous based flame retardants; (d) metal hydroxides; (e) melamine based flame retardants; (f) zinc borate; (g) low melting glasses; and (h) silicon-based materials. When choosing the appropriate flame retardant material the following considerations should be taken into account:

1. toxicity of the flame retardant

2. compatibility of the flame retardant with a film and/or adhesive to form optically clear product

3. cost of the flame retardant.

US patent application 20030031874 “Flame retardant optical films” by Valinski, et al. teaches fabrication of optically clear flame retardant films by using halogenated flame retardants. However, there is a growing concern about halogenated flame retardants and their impact on the environment and human health. For example, polybrominated diphenyl ethers (PBDE) have been found to cause immune suppression, altered sexual development, cancer, delayed brain development, lower IQ, and behavioral problems like hyperactivity in humans. Some types of PBDEs concentrate in the fatty tissues of living organisms. As a result, they bioaccumulate, or build up in the food chain, and now can be found in human blood, fat tissue, and breast milk. When exposed to sunlight or when ingested by animals, some forms of PBDEs which do not themselves readily bioaccumulate may degrade in the environment into more bioaccumulative compounds.

It is also challenging to incorporate flame retardant materials into polymeric films without compromising their optical clarity by causing “haze”. Most anti-graffiti flame retardant films and cockpit shade films developed up-to-date do not meet this requirement. One or more embodiments of the present invention, allow for development of flame retardant, environmentally friendly, economically acceptable and optically clear anti-graffiti films and cockpit shade films.

### SUMMARY OF THE INVENTION

In one embodiment, the invention relates to a composite film structure comprising at least one film and a flame retardant adhesive composition comprising a phosphorus-based flame retardant, an adhesive base, and an organic solvent, wherein the adhesive composition does not contain a halogenated flame retardant.

In another embodiment, the invention relates to a composite film structure comprising at least one film and a flame retardant adhesive composition comprising a phosphorus-based flame retardant, an adhesive base, and an organic solvent, wherein the clarity of the structure is less than 10% haze as determined by the scattering of visible light passing through the polymeric materials.

In a further embodiment, the invention relates to a process of manufacturing a composite film structure comprising coating at least one film with a flame retardant adhesive composition comprising a phosphorus based flame retardant, an adhesive base, and an organic solvent, wherein the adhesive composition does not contain a halogenated flame retardant.

### BRIEF DESCRIPTION OF THE DRAWINGS

The present invention will become more fully understood from the detailed description given below and the accompanying drawings which are given by way of illustration only, and thus do not limit the present invention.

FIG. 1 is a cross-sectional view with various layers separated from one another for better visualization showing a flame retardant anti-graffiti film of one embodiment of the present invention.

FIG. 2 is a cross-sectional view with various layers separated from one another for better visualization showing a flame retardant coated film of one embodiment of the present invention.

FIG. 3 is a cross-sectional view with various layers separated from one another for better visualization showing a flame retardant shade material with a tinted polyester adhesive of one embodiment of the present invention.

FIG. 4 is a cross-sectional view with various layers separated from one another for better visualization showing a flame retardant shade material with two metallized polyester films and a tinted polyester adhesive of one embodiment of the invention.

FIG. 5 is a cross-sectional view with various layers separated from one another for better visualization showing a flame retardant shade material with two metallized polyester films and a polyester adhesive of one embodiment of the present invention.

FIG. 6 is a cross-sectional view with various layers separated from one another for better visualization showing a flame retardant cockpit shade material with a polyester adhesive of one embodiment of the present invention.

### DETAILED DESCRIPTION OF THE INVENTION

One or more embodiments of the present invention relate to flame-retardant, optically clear anti-graffiti films which are excellent in optical clarity, flame resistance, etc. More particularly, they relate to flame-retardant compositions which exhibit good flame retardancy without using halogen-based flame retardants, and yet are still excellent in optical clarity.

One or more embodiments of the present invention may relate to flame-retardant, optically clear films used for window shades, solar control window shades and solar control window films which are excellent in optical clarity, flame resistance, etc. More particularly, they may relate to such flame-retardant compositions which exhibit good flame retardancy without using halogen-based flame retardants, and are excellent in optical clarity.

One or more embodiments of the present invention relate to flame retardant, optically clear films comprised of phosphorous based flame retardants. The major groups of phosphorous based flame retardants are phosphate esters, polyols, phosphonium derivatives and phosphonates. The phosphate esters include but are not limited to trialkyl derivatives such as triethyl or trioctyl phosphate, triaryl derivatives such as triphenyl phosphate and aryl-alkyl derivatives such as 2-ethylhexyl-diphenyl phosphate. Examples of flame retardant materials useful in the present invention are REOFOS™ 50, REOFOS™ NHP and REOFOS™ BAPP from Great Lakes Chemical Corporation, and NCENDX™ P30 from Albemarle Corporation.

The basic flame retarding mechanism of phosphorous-containing flame retardants involves thermal conversion of the phosphorous-containing retardant to phosphoric acid in the condensed phase of the plastic. The phosphoric acid extracts water from the burning plastic, causing it to char. The char insulates the plastic from flame and heat, preventing volatile, combustible gases from exiting the bulk. Silicon-modified polyurethanes are shown to have a significant decrease of heat release during the fire. Hydrogen bonding between silanols increases polymers melt viscosity and contributes to the lower heat release rates. Also, silica surface layers formed during the fire, act as a thermal insulation to protect virgin polymer and as a barriers against the migration of the thermal degradation products to the surface.

Transparency is defined by total transmittance, haze and clarity. Total transmittance is the ratio of total transmitted light to incident light. It is reduced by reflectance and absorbance. Haze is the percentage of transmitted light that deviates from the incident beam by more than about 2.5 degrees on average; it is a ratio of the diffuse only transmittance to total transmittance. Clarity is the characteristic of a transparent material, whereby distinct images may be observed through it; it is a percentage of transmitted light that deviates from the incident beam by less than 2.5 degrees on the average.

As used herein, substantially transparent refers to those materials having total transmittance of between 80 to 100 percent of light transmittance for non-tinted films, haze less than 2% for non-metallized films and clarity of 90% and higher. Haze less than 10% for metallized films.

Optically clear films are generally those having less than about 25% haze as determined by the scattering of visible light passing through polymeric materials. However, typically, the naked eye can still detect haze at levels above about 2% haze.

Optically clear films are typically provided as composite laminates comprising two or more optically clear polymeric films. Such optically clear polymeric films typically comprise polyethylene terephthalate (PET) film, commonly in a thickness of about 12.5 micrometers (0.5 mil) to about 100 micrometers (4 mils). Additional polymer films useful in the invention include, but are not limited to, different grades of polyesters, polypropylene, polyethylene, polyethylene vinyl acetate, polycarbonates, cellulose and cellulose derivatives, polyurethanes, polyacrylates, polymethacrylates, polythiophenes, poly(3,4-ethylenedioxythio-phene)/polystyrene sulfonate, polystyrene, fluoropolymers, chlorofluoropolymers, vinylfluoropolymers, poly(vinyl chloride), polyethers, polyimides, polyetherimides, and biopolymers.

Organic solvents which may be used in this invention for the formation of adhesive and optical coating solvent solutions, include but are not limited to organic solvents such as methyl ethyl ketone (MEK), acetone, methyl isobutyl ketone (MIBK), toluene, xylene, methanol, isopropanol, ethanol, heptane, ethyl acetate, isopropyl acetate, n-butyl acetate, n-butyl alcohol or mixtures thereof.

An acrylic adhesive useful in the present invention may be obtained from LioChem Incorporated as P-162.

A polyester adhesive useful in the present invention may be obtained from Rohm and Haas as 76R40.

One aspect of one embodiment of the present invention is that phosphorus containing flame retardant materials, such as Reofos NHP, Reofos 50, etc. work synergistically with (3-isocyanatopropyl)triethoxysilane in a polyester-based adhesive enhancing its flame resistance.

An optically clear, flame retardant film of one embodiment of this invention comprises at least one layer of polyethylene terephthlate (PET), adhered to at least one optically clear layer of PET by a flame retardant adhesive.

The flame retardant optical composites of various embodiments of this invention may be fabricated with sufficient amounts of flame retardant adhesive and coating to provide composites which meet national flame retardant standards such as ANSI/SAE Z26, German Test Method DIN 4102-Part 1, B2 (1998), EN ISO 11925-2, etc.

The flame retardant adhesive compositions of various embodiments of this invention can be applied to polymeric film by any of a variety of methods known to those skilled in the art of film coating manufacture. Preferred methods include coating application by spraying, roller-coating, curtain coating, dipping or brushing.

In a preferred embodiment of the present invention, the film structure has a visible light transmission in the range of about 3 to about 90% of incident visible light in the wavelength range of 400 to 750 nanometers. In addition, it is preferred, that the film structure of one embodiment of the present invention has no more than 2% haze, preferably less than 1% haze, and more preferably less than 0.5% haze.

The film structures of this invention may include any conventional solar control element. Thus, the films of this invention may include various types of coatings, layers and compositions which effect the transmission and/or reflection of light through the film structure. Accordingly, the flame resistant film structure of the present invention may include elements which block or reflect at least a portion of the incident infrared, visible or ultraviolet light. In some cases, the flame retardant films may contain light absorbers, e.g., NIR dyes and UV absorbers, light reflectors, metal coating and/or metal oxide coating on the polymeric film or a combination of light absorbers, light reflectors and/metal/metal oxide coating. Useful metals for optically active coatings on polymeric films include silver, aluminum, nickel and metal oxides such as indium oxide, tin oxide and the like. Metal and oxide coatings can be in the range of about 10 to about 100 nanometers. All or some of these components can be included in any lay of optically clear flame retardant film.

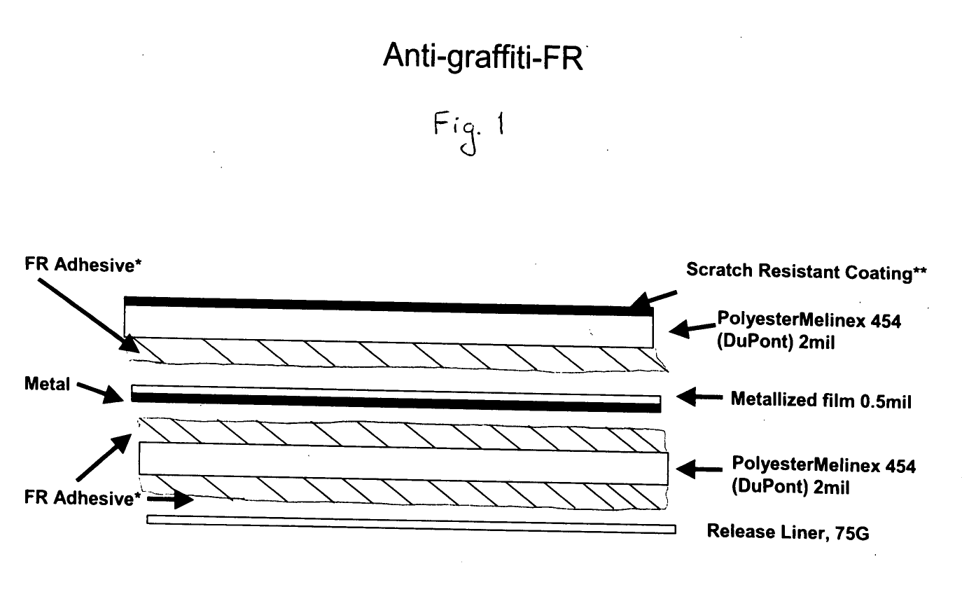

The film structures of the present invention may include a plurality of polymeric films. One embodiment of the present invention includes flame retardant anti-graffiti film as shown in FIG. 1. The composite film structure in FIG. 1 includes three polymeric film sheets with a coating of a flame retardant adhesive of the present invention between the outer films and the inner film. The composition of the flame retardant adhesive between each of the films may be the same or different. An optional pressure sensitive adhesive with a release liner is applied to the composite film structure as a means of mounting the structure.

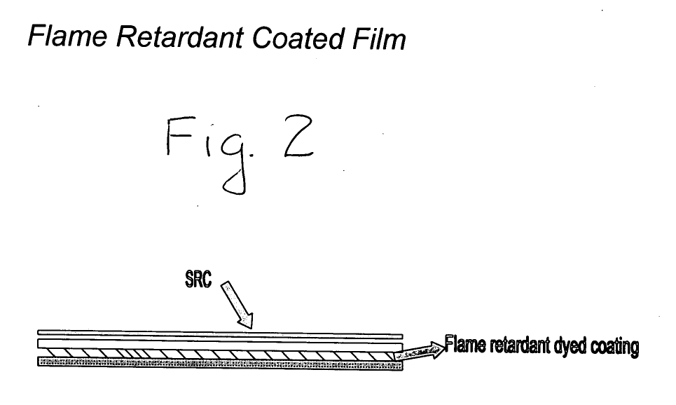

An additional embodiment of the present invention includes a flame retardant coated film as shown in FIG. 2. The composite film structure in FIG. 2 includes two polymeric film sheets adhered by a coating of a flame retardant adhesive of the present invention that has been optionally dyed. A silicone release coating is applied to the surface of one of the polymeric film sheets.

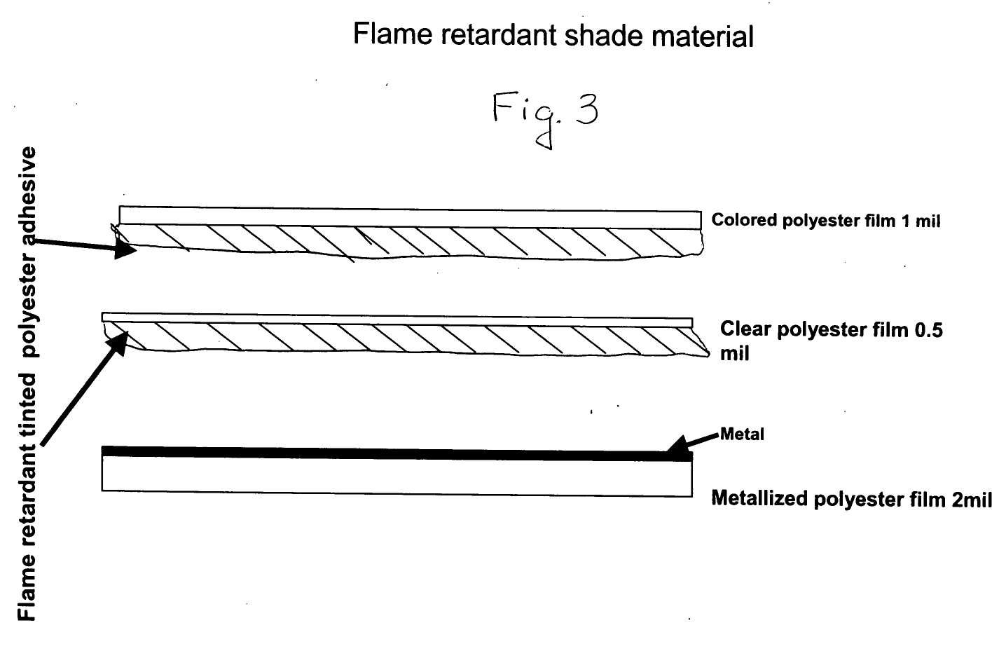

A further embodiment of the present invention includes a flame retardant shade material as shown in FIG. 3. The composite film structure includes a colored polyester adhered to a clear polyester with a flame retardant tinted polyester adhesive as described above and in Example 3 below. The same tinted polyester adhesive is then used to adhere a metallized polyethylene terephthalate (PET) polyester to the previously adhered polyesters, thereby forming a flame retardant shade material.

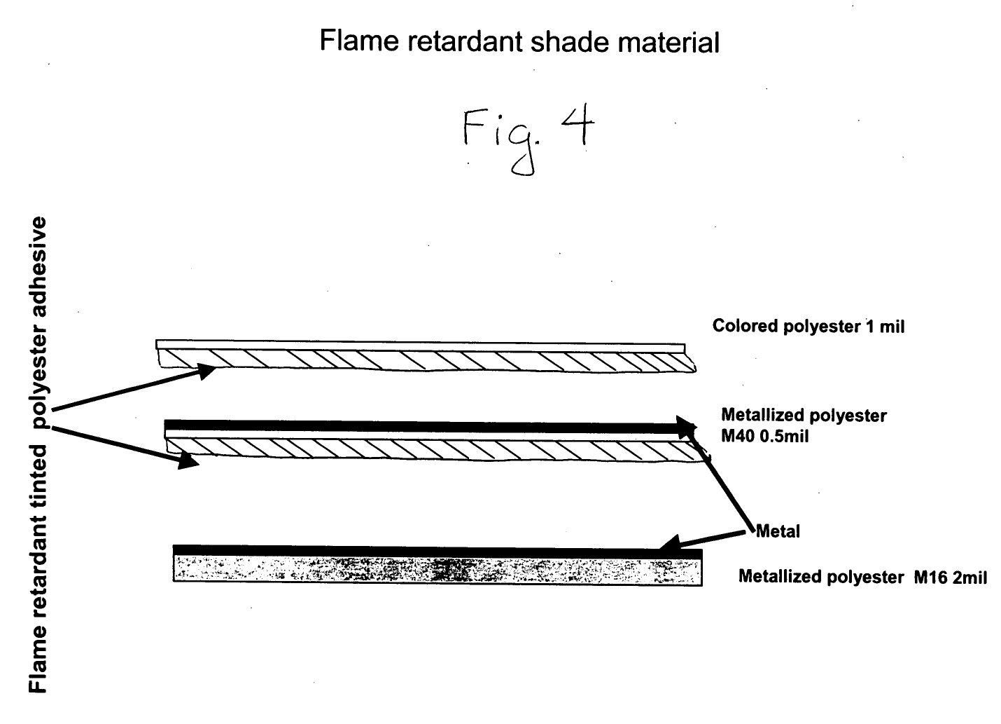

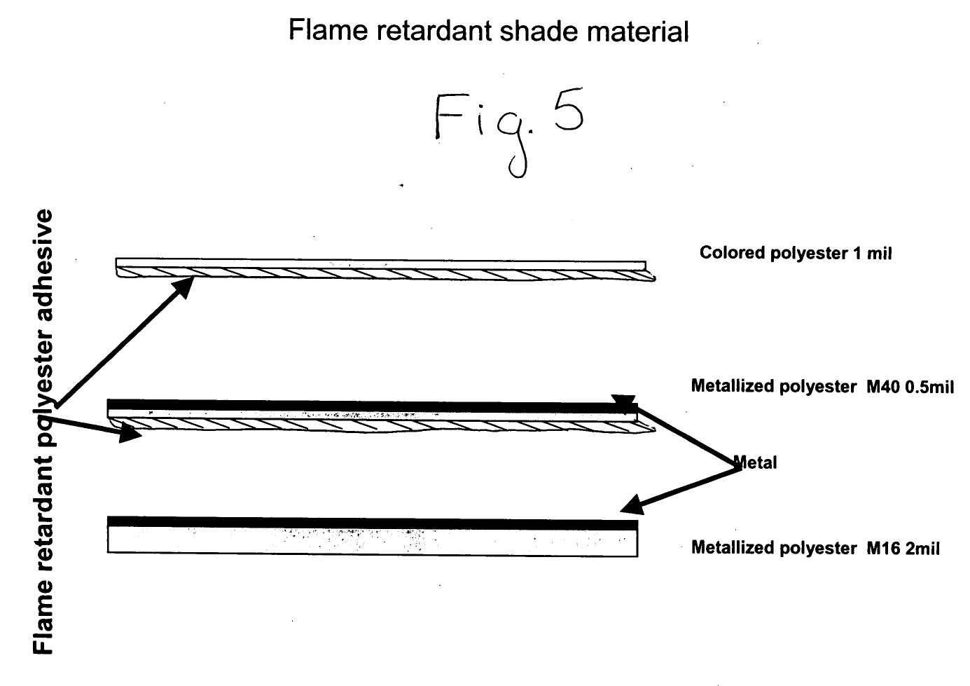

Another embodiment of the present invention is illustrated in FIG. 4. The composite film structure for a flame retardant shade material includes a colored polyester adhered to a metallized polyester, which is in turn adhered to a thicker polyester. The adhesive is a flame retardant tinted polyester adhesive as described above and in Example 3. In a further embodiment, as illustrated in FIG. 5, the flame retardant polyester adhesive between the top-middle layers and the middle-bottom layers, is not tinted.

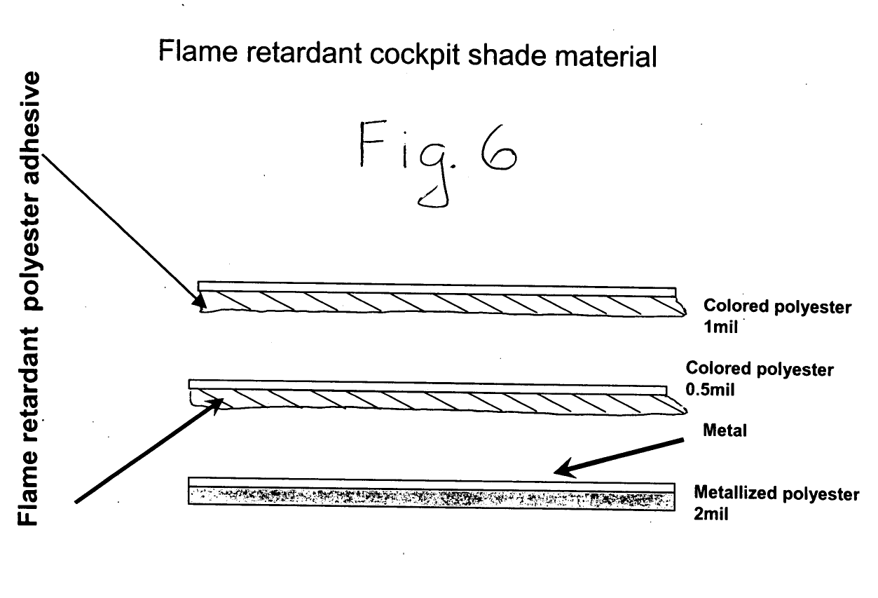

A flame retardant cockpit shade material according to one embodiment of the present invention is illustrated in FIG. 6. A tinted film, for example 613 grey film, is adhered to other tinted film of a different shade, for example an 8492 grey film, using a flame retardant polyester adhesive. Then a metallized polyester is adhered to the 8492 grey film. The flame retardant polyester adhesive is described above and in Example 3 without the tinting.

Metallized films useful in the present invention may be made by depositing metal onto a polymer surface by physical vapor deposition or by sputtering. The deposited metal can be aluminum, silver, copper, etc. In particular, M16 and M40 metallized films may be used, the designations corresponding to aluminum deposited to a particular thickness/optical density.

### Example 1

This example illustrates the preparation of a flame retardant adhesive composition according to this invention. Solutions useful for flame retardant adhesive compositions are prepared by mixing a phosphorous-based flame retardant and acrylic adhesive base in an organic solvent. In particular, such compositions are prepared by mixing 3 to 50 parts by weight of phosphorous-based flame retardant with an acrylic adhesive base and 20 to 80 parts by weight organic solvent (16 parts MEK and 16 parts toluene).

### Example 2

This example illustrates the preparation of a flame retardant coating composition according to this invention. Solutions useful for flame retardant coating compositions are prepared by mixing a phosphorous-based flame retardant, polyester polyol base, appropriate dye blend and UV absorber in an organic solvent. In particular, such compositions are prepared by mixing 3 to 50 parts by weight of phosphorous-based flame retardant with 10 to 60 parts by weight of polyester polyol base, 10 to 40 parts by weight of dye blend, 2 to 20 parts by weight of UV absorber and 5 to 40 parts by weight of organic solvent (toluene).

### Example 3

Samples were prepared according to the following procedure:

Solution of acrylic or polyester base adhesive base in a blend of methyl ethyl ketone and toluene is mixed with Rheofos NHP (15% by weight) followed by the addition of crosslinking agent. Thus prepared formulation is applied on polyester film at a coating weight of 23 g/m².
Testing was carried out using a modified version of ANSI/SAE Z26.1-1996, Section 5.24

Flammability, Test 24 (More Than 1.27 mm [0.050 in] in Thickness. Three 0.5″ wide×6″ long specimens were tested. The protective film was removed prior to testing. Benchmarks were placed on each specimen: the first mark was 1″ from one end, and the second was 4″ from the same end. Each was then mounted horizontally, and at a 45° angle, inside a fume hood. The horizontal support specimen referenced in UL94, “Test for Flammability of Plastic Materials for Parts in Devices and Appliances,” section 7. Horizontal Burning Test; HB was implemented to support the flexible film. The flame was first applied for 30 seconds, then removed. Timing of the progress of the flame front was started at the point where the flame reached the 1″ benchmark and continued until the flame reached the 4″ mark. If the specimen extinguished, the Bunsen flame was then immediately brought back into contact for another 30 seconds and then removed.

All specimens self-extinguished immediately without dripping.

### Example 4

The following is a formulation for a tinted, flame retardant polyester adhesive useful for a cockpit sunshade according to the invention:

| | | |
|---|---|---|
| Adcote 76R40 (Rohm and Haas) | 140 | g |
| MEK | 68 | g |
| Uvinol 3050 (BASF) | 38 | g |
| Rheofos NHP (Chempoint) | 50 | g |
| (3-isocyanatopropyl)triethoxysilane, Gelest)) | 17 | g |
| Dye Blend | 7.06 | g |
| Silane Z-6040 (NE Resins & Pigments) | 1 | g |
| Dye blend | | |
| Orasol Black RLI (Ciba Geigy) | 1.5 | g |
| Orasol Orange G (Ciba Geigy) | 0.9 | g |
| Macrolex Violet 3R (Ciba Geigy) | 0.07 | g |
| MEK | 35.6 | g |

The materials can be combined using any of a number of procedures well known in the art.

Upon a review of the above, one of skill in the art should realize that one embodiment of the present invention is directed to a flame retardant coating composition comprising: a phosphorous-based flame retardant, an acrylic adhesive base and an organic solvent. Another embodiment of the invention is directed to a composite film structure comprising at least one polymeric film and a flame retardant adhesive composition comprising a phosphorus-based flame retardant, an acrylic adhesive base, and an organic solvent. Additionally, a further embodiment is the process of manufacturing a composite film structure according to the present invention comprising coating at least one polymeric film with a flame retardant adhesive composition comprising a phosphorus based flame retardant, an acrylic adhesive base, and an organic solvent. An additional film or coating may be applied to the adhesive composition, creating a composite film structure with the adhesive composition between the two polymeric films or between the polymeric film and the coating. Another embodiment of the invention is directed to a flame retardant coating composition comprising a phosphorous-based flame retardant, an acrylic adhesive base and an organic solvent, with the proviso that the coating composition does not contain a halogenated flame retardant.

1. A composite film structure comprising at least one film and a flame retardant adhesive composition comprising a phosphorus-based flame retardant, an adhesive base, and an organic solvent, wherein the adhesive composition does not contain a halogenated flame retardant and the clarity of the structure is less than 10% haze as determined by the scattering of visible light passing through the polymeric materials.

2. The composite film structure of claim 1 wherein the adhesive base comprises an acrylic or a polyester base.

3. The composite film structure of claim 1 wherein the film is an optically clear film.

4. The composite film structure of claim 3 wherein the optically clear film is selected from the group consisting of: polyethylene terephthalate (PET) film, polyesters, polypropylene, polyethylene, polyethylene vinyl acetate, polycarbonates, cellulose and cellulose derivatives, polyurethanes, polyacrylates, polymethacrylates, polythiophenes, poly(3,4-ethylenedioxythio-phene)/polystyrene sulfonate, polystyrene, biopolymers, fluoropolymers, chlorofluoropolymers, vinylfluoropolymers, poly(vinyl chloride), polyethers, polyimides, polyetherimides and combinations thereof.

5. The composite film structure of claim 1 wherein the organic solvent is selected from the group consisting of: methyl ethyl ketone (MEK), acetone, methyl isobutyl ketone (MIBK), toluene, xylene, methanol, isopropanol ethanol, heptane, ethyl acetate, isopropyl acetate, n-butyl acetate, n-butyl alcohol or mixtures thereof.

6. (canceled)

7. The composite film structure of claim 1, further comprising at least one of cross-linking agents, near infrared dyes, ultraviolet absorbers, light reflectors, metal coatings, and metal oxide coatings.

8. The composite film structure of claim 7 wherein the metal of the metal coating and the metal of the metal oxide coating are independently selected from the group consisting of: silver, aluminum, nickel, metal oxides, and combinations thereof.

9. The composite film structure of claim 1 wherein the phosphorus-based flame retardant is 3 to 50 parts by weight of the adhesive base, and the organic solvent is 20 to 80 parts by weight of the adhesive base.

10. The composite film structure of claim 1, further comprising a dye blend and a ultraviolet absorber, wherein the phosphorus-based flame retardant is 3 to 50 parts by weight of the adhesive base, the adhesive base is 10 to 60 parts by weight of the adhesive base, the dye blend is 10 to 40 parts by weight of the adhesive base, the ultraviolet absorber is 2 to 20 parts by weight of the adhesive base, and the organic solvent is 5 to 40 parts by weight of the adhesive base.

11. The composite film structure of claim 1, wherein the structure is used as flame retardant shade material.

12. The composite film structure of claim 11, wherein the flame retardant shade material is used in an airplane cockpit.

13. The composite film structure of claim 1, wherein the structure is optically clear and used in a decorative film.

14. The composite film structure of claim 1, wherein the structure is optically clear and used in a solar control window film.

15. A composite film structure comprising at least one film and a flame retardant adhesive composition comprising a phosphorus-based flame retardant, an adhesive base, and an organic solvent, wherein the clarity of the structure is less than 2% haze as determined by the scattering of visible light passing through the polymeric materials.

16. The composite film structure of claim 15 wherein the adhesive base comprises an acrylic or a polyester base.

17. The composite film structure of claim 15 wherein the film is selected from the group consisting of: polyethylene terephthalate (PET) film, polyesters, polypropylene, polyethylene, polyethylene vinyl acetate, polycarbonates, cellulose and cellulose derivatives, polyurethanes, polyacrylates, polymethacrylates, polythiophenes, poly(3,4-ethylenedioxythiophene)/polystyrene sulfonate, polystyrene, biopolymers, fluoropolymers, chlorofluoropolymers, vinylfluoropolymers, poly(vinyl chloride), polyethers, polyimides, polyetherimides and combinations thereof.

18. The composite film structure of claim 15 wherein the organic solvent is selected from the group consisting of: methyl ethyl ketone (MEK), acetone, methyl isobutyl ketone (MIBK), toluene, xylene, methanol, isopropanol ethanol, heptane, ethyl acetate, isopropyl acetate, n-butyl acetate, n-butyl alcohol or mixtures thereof.

19. The composite film structure of claim 15, further comprising at least one of cross-linking agents, near infrared dyes, ultraviolet absorbers, light reflectors, metal coatings, and metal oxide coatings.

20. The composite film structure of claim 19 wherein the metal of the metal coating and the metal of the metal oxide coating are independently selected from the group consisting of: silver, aluminum, nickel, metal oxides, and combinations thereof.

21. The composite film structure of claim 15 wherein the phosphorus-based flame retardant is 3 to 50 parts by weight of the adhesive base, and the organic solvent is 20 to 80 parts by weight of the adhesive base.

22. The composite film structure of claim 15, further comprising a dye blend and a ultraviolet absorber, wherein the phosphorus-based flame retardant is 3 to 50 parts by weight of the adhesive base, the adhesive base is 10 to 60 parts by weight of the adhesive base, the dye blend is 10 to 40 parts by weight of the adhesive base, the ultraviolet absorber is 2 to 20 parts by weight of the adhesive base, and the organic solvent is 5 to 40 parts by weight of the adhesive base.

23. A flame retardant coating composition comprising: a phosphorous-based flame retardant, an adhesive base and an organic solvent, wherein the adhesive composition does not contain a halogenated flame retardant.

24. The flame retardant coating composition of claim 23, wherein the adhesive base comprises an acrylic or a polyester base.

25. Process of manufacturing a composite film structure comprising coating at least one film with a flame retardant adhesive composition comprising a phosphorus based flame retardant, an adhesive base, and an organic solvent, wherein the adhesive composition does not contain a halogenated flame retardant.

26. The process of claim 25, wherein, the adhesive base comprises an acrylic or a polyester adhesive base.
